(19) United States
(12) Patent Application Publication
(10) Pub. No.: US 2003/0014289 A1
(43) Pub. Date: Jan. 16, 2003

(54) Method for transmitting logistics information

(76) Inventors: Chen-Ching Chu, Pan-Chiao (TW); Guang Ouyang, shenzhen (CN); Yonggang Dong, Shenzhen (CN)

Correspondence Address: Wei Te (Joseph) Chung, Foxconn International, Inc., 1650 Memorex Drive, Santa Clara, CA, 95050, US

(21) Appl. No.: 09/962,531

(22) Filed: Sep. 21, 2001

(30) Foreign Application Priority Data
Jul. 10, 2001 (TW) 90116834

(51) Int. Cl. G06F 17/60

(52) U.S. Cl. 705/7

(57) ABSTRACT

A method for transmitting logistics information among a plurality of role players includes a logistics control system operating on an electronic communications network. The system has a security mechanism which assigns different authorities to various role players in accordance with a particular function of each role player. Logistics information provided by any role player under his authority can be posted onto a shared area of a network server. Only role players who are so authorized can access the logistics information. Access can be done in real time. Thus logistics information can be transferred and shared in real time, while confidential information as between two role players is not accessible by a third role player.

### BACKGROUND OF THE INVENTION

1. Field of the Invention

The present invention relates to methods for managing logistics information and, more particularly, to electronic methods for transmitting logistics information among a plurality of role players in a logistics process having a security mechanism.

2. Related Art

At the present time, international logistics is widely used in order to match supply and demand all over the world. Generally, a simple logistics process involves three parties: a sending party, a receiving party, and a forwarding party. In a purchasing process, the corresponding three parties are generally a purchaser, a vendor, and a forwarder. The purchaser generally undertakes material requirement planning (MRP) according to his demands, and sends an MRP order to a vendor by fax or other conventional means. The vendor then obtains items required in the MRP, and informs the purchaser and a forwarder of relevant information by fax or other conventional means. Finally, the forwarder transports the items to a location specified by the purchaser. In order to complete the purchasing process promptly, operations as between the purchaser, the vendor and the forwarder must be collaborative. Any information required during the logistics process must be transferred to the relevant party promptly.

For example, a purchaser in a first country can send ordering information to a vendor in a second country. The vendor in the second country then supplies items according to the ordering information, and entrusts a forwarder to deliver the items to a location specified by the purchaser. For example, the purchaser in the first country needs one kind of item such as a computer hard disk, and the vendor of this kind of hard disk is in the second country. The purchaser sends his order for the hard disks to the vendor by conventional means such as telephone or fax. After receiving the order, the vendor supplies the hard disks according to the order. The vendor entrusts the forwarder to transport the hard disks to the location specified by the purchaser. During this process, the transfer of information still depends on conventional means such as phone or fax.

Global logistics transcends boundaries of nations. The whole logistics process depends on good communication. Prompt and reliable communication is key to achieving highly efficient logistics.

Transferring information by conventional means such as telephone or fax is costly and inefficient. International charge rates for fax and telephone are notoriously expensive. Such communication is inherently slow, and frequently subject to delay. Furthermore, in a multi-party logistics network, any one party-to-party communication inevitably delays a subsequent communication which depends on that earlier communication but which involves a third party. Consequently, the whole logistics process is inherently slow.

With the rapid development of the World Wide Web, logistics processes can now be controlled with the help of computers and the Internet. Up to now, computer-related methods have mainly focused on the process from departure of ordered items from a vendor to arrival of the items at a designated destination. Role players in such logistics processes have had to obtain or download specific software to be able to participate. The FedEx® Ship Manager software of Federal Express and the OnLine® WorldShip® system of United Package Service epitomize the current technology. What is still needed is means that allow each role player to participate in a logistics process easily, and that provide transfer of information as between a multiplicity of role players such that the whole logistics process can be effectively controlled.

### SUMMARY OF THE INVENTION

It is an object of the present invention to provide a logistics control method for transmitting logistics information whereby a security mechanism can assign different authorities to various role players in a supply chain such that each role player can only access specific predetermined logistics information.

It is another object of the present invention to provide a logistics control method by which each role player can control a logistics process in order to attain delivery and receipt of items on time.

In order to achieve the above mentioned objects, a method for transmitting logistics information among a plurality of role players includes a logistics control system operating on an electronic communications network. The system has a security mechanism with a log-in window that only allows role players having authority to log in to the system. The system initially identifies a role player according to his log-in name and password, and then assigns access to the role player in accordance with the particular authority of the role player. Logistics information provided by any role player under his authority can be posted onto a shared area of a web server. Only role players who are so authorized can access the logistics information. Access can be done in real time. Therefore logistics information can be transferred and shared in real time, while confidential information as between two role players is not accessible by a third role player.

In addition, there is provided according to another aspect of the present invention a logistics control method for transmitting logistics information in a community of role players, the logistics control method comprising the steps of: generating ordering information for an item by a first portion of the role players, and posting the ordering information on a logistics control system on an electronic communications network; accessing the ordering information on the system by a second portion of the role players, and organizing supply of the item according to the ordering information; generating shipment information regarding transportation of the item and posting the shipment information on the system by the second portion of the role players; and accessing the shipment information on the system, generating dispatch confirmation information, and posting the dispatch confirmation information on the system by a third portion of the role players.

### BRIEF DESCRIPTION OF THE DRAWINGS

FIG. 1 is a schematic diagram of information exchange as between role players of a logistics control system in accordance with a preferred embodiment of the present invention;

FIG. 2 is a flowchart illustrating a logistics process of a vendor participating in the system of the present invention;

FIG. 3 illustrates a computer display log-in window for accessing the system of the present invention;

FIG. 4 illustrates a computer display window showing a list of accessible icons for accessing various working windows;

FIG. 5 illustrates a computer display working window for accessing information on approved vendors;

FIG. 6 is a general flowchart of a logistics process controlled by the system of the present invention; and

FIG. 7 is an ordering flowchart of a logistics process controlled by the system of the present invention.

### DETAILED DESCRIPTION OF A PREFERRED EMBODIMENT OF THE INVENTION

A logistics control system 100 of the present invention is provided on an electronic communications network. In the preferred embodiment, the logistics control system 100 is provided on the Internet. The logistics control system 100 assigns authorities to a plurality of role players involved in a logistics process. Each role player can log in to the logistics control system 100 and communicate with any other role player in accordance with respective predetermined authorities. The role players exchange logistics information in real time.

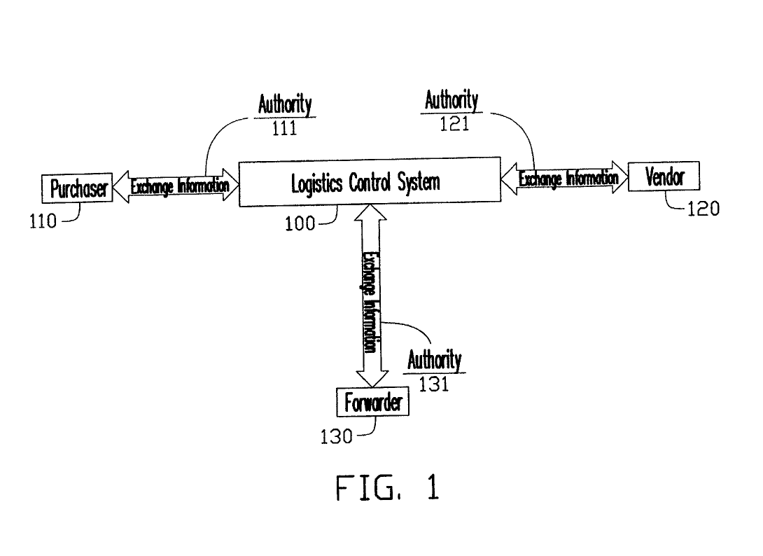

FIG. 1 illustrates such process of exchanging information. A purchaser 110, a vendor 120 and a forwarder 130 located anywhere in the world can access the logistics control system 100 from respective computer terminals (not shown) at respective locations. For example, the purchaser 110 may be in Asia and may need one kind of computer storage equipment such as a particular kind of hard disk. The vendor 120 of such hard disks may be in the United States. In this example, the purchaser 110 need only initiate a purchasing order (PO) for the hard disks on his computer terminal in Asia in accordance with his authority 111, and then post the PO on the logistics control system 100. The vendor 120 in the United States can access the PO in real time via his computer terminal in accordance with his authority 121. After confirming the PO, the vendor 120 organizes supply of the hard disks. The vendor 120 then posts a shipping notice (SN) on the logistics control system 100. In real time, the forwarder 130 can access the SN on his computer terminal in accordance with his authority 131. T he forwarder 130 then arranges transportation of the hard disks to a site specified by the purchaser 110. Each party that participates in this logistics process for exchanging information does so within the scope of his respective authority 111, 121, 131. Each authority 111, 121, 131 may be limited. For example, each role player may exchange logistics information only with other predetermined role players, and may also process predetermined confidential information only with other predetermined role players.

If, for example, logistics are required to be performed within a single organization, the logistics control system 100 can be constructed on an intranet of the organization. Further, one or more role players may be connected to the logistics control system 100 by one or more intranets. In yet another configuration, the logistics control system 100 may be provided on a combination of the Internet and one or more intranets.

In the preferred embodiment, the invention is now described by focusing on the purchaser 110. In a typical logistics process, the purchaser 110 deals with not just one vendor 120, but rather a variety of vendors 120 who supply various kinds of goods or services. For convenience, only supply of goods will be described hereafter. An identical item of goods may be available from a variety of vendors 120. Similarly, a variety of forwarders 130 may be available for transferring items from any vendor 120 to the purchaser 110. Even within a single organization, various departments purchasing independently may be the equivalent of “small” purchasers 110. Therefore, many role players may need to participate in a logistics process. Means for controlling and coordinating the role players are described below.

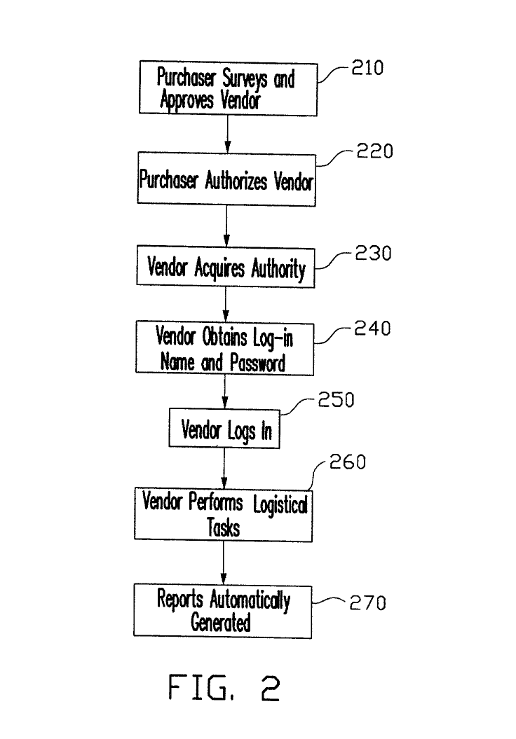

FIG. 2 illustrates a vendor 120 (not shown) participating in a logistics process. In a typical purchasing process, assuming that an ongoing purchasing network has already been established, the purchaser 110 (not shown) frequently still looks for new vendors to expand the purchaser's sources of supply. The purchaser 110 firstly surveys and approves a vendor according to criteria such as the vendor's product quality and capacity to deliver (step 210). The purchaser 110 then grants specific authority to the vendor 120 by assigning him with a specific log-in name and accompanying password in accordance with a supplying function of the vendor 120 (step 220). The specific authority includes ability to communicate with other role players, and construction of a data bank of confidential information belonging to the vendor 120. After acquiring the specific authority (step 230), the vendor 120 can gain access to the logistics control system 100 (step 240) by using the assigned log-in name and password. Similarly, the purchaser 110 may have new extra demand for transportation services. The purchaser 110 surveys and approves a new forwarder 130, and grants specific authority to the forwarder 130 by assigning him with a specific log-in name and accompanying password. Other role players participating in the logistics process may also follow similar procedures as described above. Each role player having authority, namely a log-in name and password, can join the logistics process directly. After log-in (step 250), the vendor 120 can enter the logistics control system 100 to perform necessary logistical tasks (step 260). Orders generated during execution of logistical tasks are eventually automatically turned into corresponding electronic reports in the logistics control system 100 (step 270).

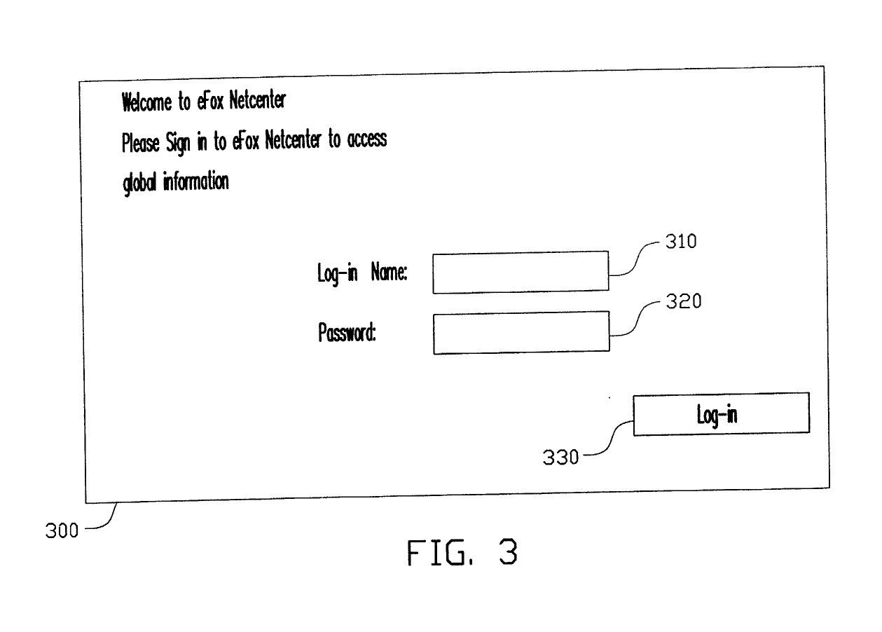

FIG. 3 illustrates a log-in window 300 for role players to access the logistics control system 100. Each role player having specific authority 111, 121, 131 can enter the logistics control system 100. The log-in window 300 provides an entrance for each role player to enter a variety of working windows according to his particular authority 111, 121, 131, and thereby perform certain logistical tasks. Each role player enters the log-in window 300 with his log-in name and password. In the preferred embodiment, the log-in window 300 includes a log-in name blank 310 and a password blank 320. Each log-in name and accompanying password are encoded such that they automatically limit the scope of the logistics control system 100 that each authorized role player can access. An authorized role player fills in the log-in name blank 310 and the password blank 320, and clicks a “log-in” button 330. The logistics control system 100 identifies the role player according to the log-in name and password, and automatically allows the role player to visit only certain specific working windows (not shown) included within the scope of the role player's respective authority 111, 121, 131.

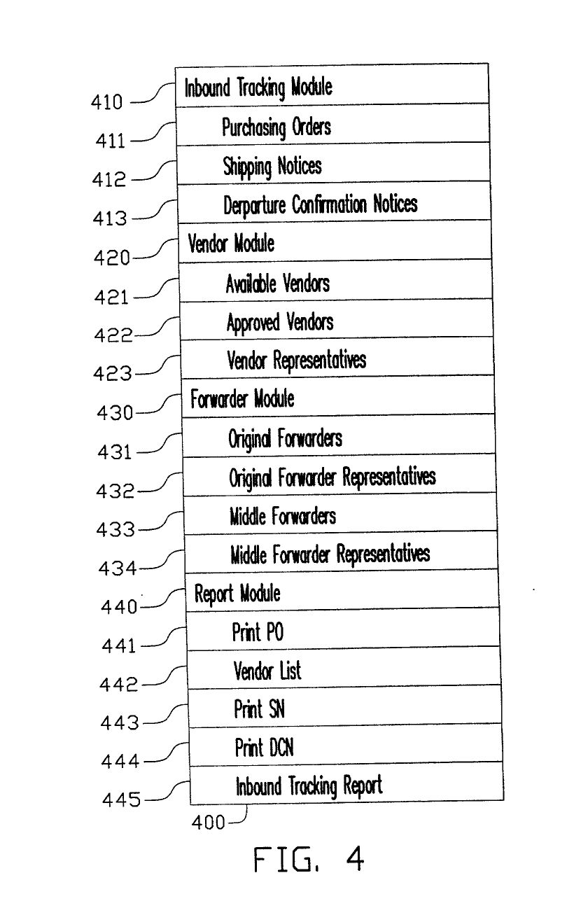

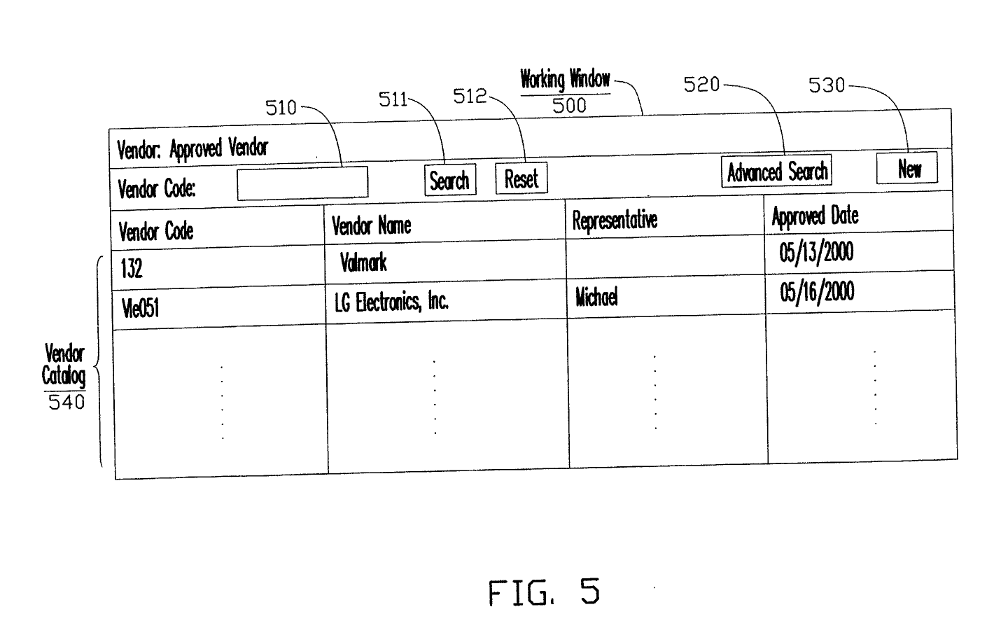

FIG. 4 is an access control list 400 included within the authority 111 of one purchaser 110 in a logistics process. In the preferred embodiment, the access control list 400 includes four modules: (i) an inbound tracking module 410; (ii) a vendor module 420; (iii) a forwarder module 430; and (iv) a report module 440. Each module includes various access control items. In the preferred embodiment, the purchaser 110 can access specific working windows to perform certain logistical tasks by clicking on one of the access control items listed under each module. For example, in the inbound tracking module 410, the purchaser 110 can click on: (i) a purchasing orders item 411 for entering a specific window where the purchaser 110 is guided to make purchasing orders according to his requirements; (ii) a shipping notices item 412 for entering a specific window where the purchaser 110 can check issued shipping notices; and (iii) a departure confirmation notices item 413 for entering a specific window where the purchaser 110 can check issued departure confirmation notices. Similarly, in the vendor module 420, the purchaser 110 can click on: (i) an available vendors item 421 for ascertaining which vendors anywhere in the world can offer suitable products; (ii) an approved vendors item 422 for confirming which vendors have already supplied products for the purchaser 110; and (iii) a vendor representatives item 423 for checking representatives of the approved vendors. Similarly, in the forwarder module 430, the purchaser 110 can click on: (i) an original forwarders item 431 to find information concerning original forwarders; (ii) an original forwarder representatives item 432 to check information concerning representatives of the original forwarders; (iii) a middle forwarders item 433 to find information concerning middle forwarders who cooperate with the original forwarders; and (iv) a middle forwarder representatives item 434 to check information concerning representatives of the middle forwarders. In the report module 440, the purchaser 110 can only click on: (i) a print purchasing order item 441; (ii) a vendor list item 442; (iii) a print shipping notice item 443; (iv) a print departure confirmation notice item 444; and (v) an inbound tracking report item 445. The purchaser 110 can access further working windows linked to any one or more of the above-described items. For example, when the purchaser 110 clicks on the approved vendors item 422, he can further access a working window 500 (see FIG. 5) relating to approved vendors information. This is done by clicking on a hyperlink, as described in detail below. There are also other items in the access control list 400 which are not shown in FIG. 4. This is because the purchaser 110 does not have authority to access corresponding working windows linked to such items.

FIG. 5 shows the working window 500 corresponding to the approved vendors item 422. A vendor catalog 540 including a plurality of vendor codes is located at a lower portion of the working window 500. In the working window 500, the purchaser 110 can input a vendor code in a vendor code blank 510. The purchaser 110 then clicks on a “search” button 511, and the logistics control system 100 provides the purchaser 110 with access to information about the vendor represented by the vendor code. The purchaser 110 can query or modify such information. T he purchaser 110 can click on a “reset” button 512 to renew the vendor code. By clicking on one of the vendor codes in the vendor catalog 540, the purchaser 110 can easily access detailed information on the selected vendor. The purchaser 110 can also search for a specific vendor that meets certain specific requirements by clicking on an “advanced search” button 520. The purchaser 110 can click on a “new” button 530 to add a newly approved vendor to the vendor catalog 540.

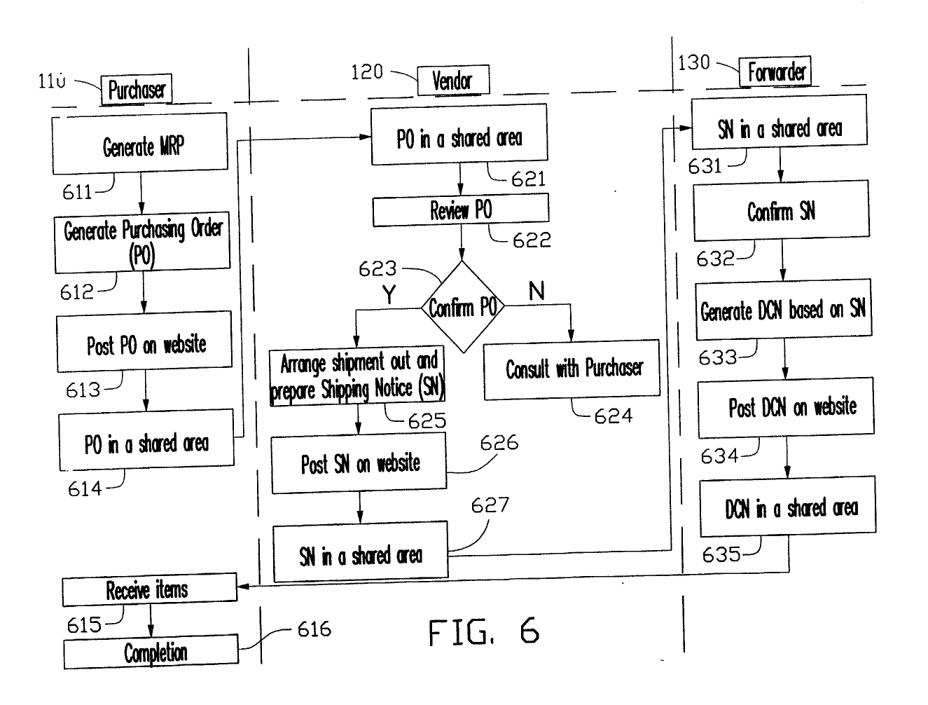

FIG. 6 illustrates relationships among the purchaser 110, the vendor 120 and the forwarder 130 in a purchasing process. After generating a material requirement plan (MRP) (step 611), the purchaser 110 makes a purchasing order (PO) based on the MRP (step 612). The purchaser 110 then posts the purchasing order on a website of the logistics control system 100 (step 613). This process is accomplished within the purchaser's authority 111. The purchasing order posted on the website is actually stored in a shared area of a web server (step 614). The vendor 120 can access the purchasing order via the Internet from anywhere in the world in real time (step 621). After retrieving the purchasing order, the vendor 120 reviews (step 622) and confirms (step 623) it. The vendor 120 may consult with the purchaser 110 if the purchasing order is not clear (step 624). After confirming the purchasing order (step 623), the vendor 120 obtains items according to the purchasing order and prepares a shipping notice (step 625). After preparing the shipping notice, the vendor 120 posts it on the website (step 626). The shipping notice is stored in a shared area of the web server (step 627). The forwarder 130 can access the shipping notice via the Internet from anywhere in the world in real time (step 631). The forwarder 130 then confirms the shipping notice (step 632). After arranging for dispatch of the items, the forwarder 130 generates a departure confirmation notice (DCN) in accordance with the shipping notice (step 633). The forwarder 130 posts the departure confirmation notice on the website (step 634). The departure confirmation notice is stored in a shared area of the web server (step 635), for the attention of the purchaser 110 and the vendor 120. The items required by the purchaser 110 are dispatched to a specified destination (step 615). Thereupon, the whole logistics process has been completed (step 616).

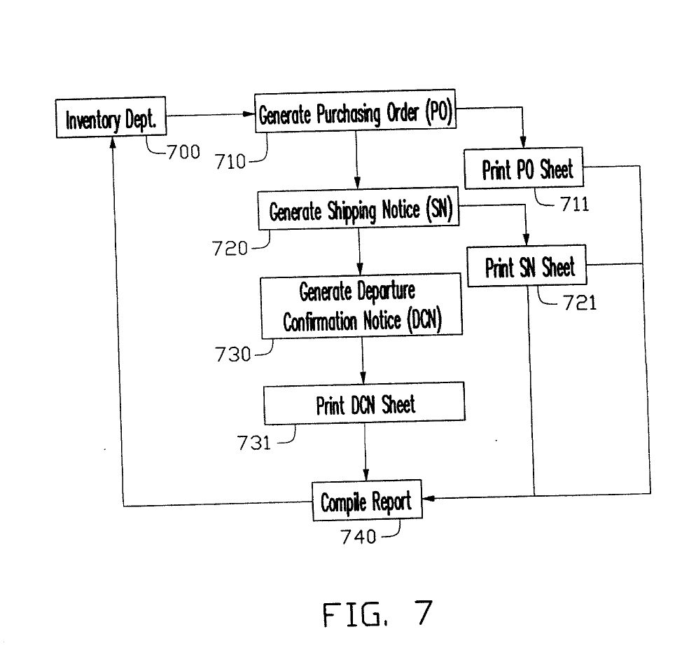

FIG. 7 is an ordering flowchart of a logistics process controlled by the system of the present invention. After an inventory department 700 of the purchaser 110 generates a purchasing order of required items (step 710), the purchasing order results in two subsequent steps. First, the purchasing order is stored in an information sharing area, thus allowing the vendor 120 to access the purchasing order and generate a shipping notice (step 720). Second, the purchasing order is turned into an electronic report that can be printed out in hardcopy by clicking on the print PO item 441 under the report module 440 of FIG. 4 (step 711). Similarly, the shipping notice generated by the vendor 120 also results in two subsequent steps. First, the shipping notice is stored in an information sharing area, thus allowing the forwarder 130 to access the shipping notice and generate a departure confirmation notice (step 730). Second, the shipping notice is turned into an electronic report that can be printed out in hardcopy by clicking on the print SN item 443 under the report module 440 of FIG. 4 (step 721). The departure confirmation notice generated by the forwarder 130 can be printed out in hardcopy by clicking on the printing DCN item 444 under the report module 440 of FIG. 4 (step 731). Eventually, all the hardcopies of notices can be compiled into a report (step 740). The inventory department 700 of the purchaser 110 can review such report. Each role player can access relevant electronic reports by clicking on the relevant items listed under the report module 440.

The preferred embodiment illustrates logistics involving a purchaser, a vendor, and a forwarder. However, the present invention is applicable to activities concerning logistics generally. Accordingly, the present invention is not to be construed as being limited to logistics involving a purchaser, a vendor and a forwarder. Activities relating to transfer of goods and/or services generally are also included within the spirit and scope of the present invention.

What is claimed is:

1. A method for transmitting logistics information in a community of role players, the method comprising:
providing a logistics control system on an electronic communications network upon which logistics information can be transmitted on-line by the role players;
assigning each role player an authority to access the system, the authority being commensurate with that role player's function in the system;
providing a log-in window for each role player having authority to access the system;
assigning corresponding access control items from an access control list to each role player in accordance with the authority of that role player.

2. The method as claimed in claim 1, wherein the electronic communications network comprises communications networks selected from the group consisting of the Internet and at least one intranet.

3. The method as claimed in claim 1, wherein the information transmitted on-line is stored in a shared area of a web server.

4. The method as claimed in claim 1, wherein the system is an open system that can be accessed by role players having authority.

5. The method as claimed in claim 4, wherein the system can identify an authority of any role player according to a log-in name and password entered by the role player, and then allow access to that role player according to the authority identified.

6. The method as claimed in claim 5, wherein a scope of the access allowed to any one role player is defined by a plurality of displayed functional icons which may be accessed by the role player, each icon providing a specific working window.

7. The method as claimed in claim 1, wherein any role player having authority can only access a portion of the system.

8. The method as claimed in claim 1, wherein the access control list comprises an inbound tracking module for processing information about purchased items.

9. The method as claimed in claim 1, wherein the access control list comprises a vendor module for providing information on vendors.

10. The method as claimed in claim 1, wherein the access control list comprises a forwarder module for providing information on forwarders.

11. The method as claimed in claim 1, wherein the access control list comprises a report module for providing reports of orders made.

12. A method for transmitting logistics information in a community of role players, the method comprising:
generating ordering information for at least one item by a first portion of the role players, and posting the ordering information on a logistics control system on an electronic communications network;
accessing the ordering information on the system by a second portion of the role players, and organizing supply of the at least one item according to the ordering information;
generating shipment information regarding transportation of the at least one item and posting the shipment information on the system by the second portion of the role players; and
accessing the shipment information on the system, generating dispatch confirmation information and posting the dispatch confirmation information on the system by a third portion of the role players.

13. The method as claimed in claim 12, wherein the electronic communications network comprises communications networks selected from the group consisting of the Internet and at least one intranet.

14. The method as claimed in claim 12, wherein the ordering information is stored in a shared area of the system.

15. The method as claimed in claim 12, wherein the second portion of the role players can access the ordering information in real time.

16. The method as claimed in claim 12, wherein the shipment information is stored in the shared area of the system, and the shared area is accessible by the second portion and the third portion of the role players.

17. The method as claimed in claim 12, wherein the third portion of the role players can access the shipment information in real time.

18. A method for trading goods and transmitting corresponding logistics information among a purchaser, a vendor and a forwarder, comprising the steps of:
providing a system sharing with the purchaser, the vendor and the forwarder while each having different authorities to enter some portions of the whole system;
the purchaser entering the system and posting an order information thereon;
the vender informed of the incoming order information, entering the system and accessing details of the order information and preparing supply of at least some items requested by said order information;
the vender further posting shipment information on the system once said supply is ready;
both of said purchaser and said forwarder informed of said shipment information; wherein
the forwarder enters the system and further posts dispatch confirmation information on the system which the purchaser and the vender are later informed of.
